(19) United States
(12) Patent Application Publication
(10) Pub. No.: US 2009/0240619 A1
(43) Pub. Date: Sep. 24, 2009

(54) MULTI-NATIONAL GIFT CARD SETTLEMENT

(75) Inventors: Theodore VanDeburg, Denver, CO (US); Douglas A. Swartz, Omaha, NE (US); Elizabeth M. Toeniskoetter, Denver, CO (US); Judith K. Turek, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 12/053,419

(22) Filed: Mar. 21, 2008

(51) Int. Cl. G06Q 40/00

(52) U.S. Cl. 705/39; 705/35

(57) ABSTRACT

Systems and methods for settling stored value account transactions between merchants in countries that use different currencies. A host computer system receives transaction data resulting from a number of stored value account transactions performed at a number of merchants. The merchants are grouped into separate entities with separate accounting systems, and at least one entity operates in a different country than another entity. The transactions include any combination of origination transactions, redemption transactions, and reload transactions, and the transaction data includes for each redemption and reload transaction a transaction amount, locations in which the transaction occurred and the account was originated and the base currency of the account and the currency in which the transaction is performed. Periodically, accounts are settled between the entities in each country using a central country bank account in each country, and periodically accounts are settled between pairs of central country bank accounts.

### BACKGROUND OF THE INVENTION

Stored value accounts, such as those represented by gift cards, are a convenient way for consumers to make purchases. In one simple embodiment of a stored value account, a consumer gives an amount of money to a merchant. The merchant typically holds the deposited money without recognizing it as revenue. The merchant initiates an account for the consumer, assigns an account number to the account, and credits the account for the amount of money received. Often, the consumer is given a card or other presentation instrument with the account number stored on it. The consumer may use the account, or may give the stored value as a gift, for example in the form of a gift card.

The holder of the stored value account, whether the consumer or the recipient of the account as a gift, can then make purchases funded by the account by simply presenting the account identifier at the time of a purchase. For example, the account holder may present a gift card having the account number stored on it. The account number may be read from the card using a point of sale device or other means, and the account debited by the amount of the purchases made (up to the amount in the account). Once a purchase is made with funds from the account, the merchant can recognize the redemption amount as revenue.

The original transaction in which a stored value account is created may be referred to as an account initiation, origination, or activation transaction. When funds from the account are used to make a purchase, the transaction is referred to as a redemption. A third kind of transaction is also possible, and is referred to as a reload transaction. In a reload transaction, the account holder (or another) gives money to the merchant to be credited to the existing account, so that the account balance available for making purchases is increased.

The operation stored value accounts may be made more complicated when merchants that are part of separate accounting entities wishing to honor stored value accounts between the accounting entities. This situation may arise, for example, among franchisees that appear to consumers to be part of a large chain of merchants, but that are in fact independently operated businesses with separate accounting systems. When a consumer originates a stored value account at one such merchant and redeems some of the stored value at another, the redeeming merchant may initially suffer a detriment, as it provides goods or services to the consumer, but does not have the funds, or even ready access to the funds, originally presented when the account was originated. The situation is further complicated when the merchants reside in different countries using different currencies. For example, for a redemption transaction performed using an account that was originated in a country different than the country in which the redemption occurs, the funds received at the time of activation of the stored value account may be held in the originating country, and not in the country of the redeeming merchant.

There is a need for a system and method to fairly settle stored value transactions between merchants who use different currencies.

### BRIEF SUMMARY OF THE INVENTION

In one embodiment, a method of settling financial accounts comprises receiving, at a host computer system, transaction data resulting from a plurality of transactions performed at a plurality of merchants. The merchants are grouped into separate entities with separate accounting systems, and at least one entity operates in a different country than at least one other entity. The transactions relate to customer stored value accounts, and the plurality of transactions comprises any combination of origination transactions, redemption transactions, and reload transactions. The transaction data comprises for each redemption and reload transaction a transaction amount, a location in which the transaction occurred, a location in which the affected stored value account was originated, a base currency of the affected stored value account, and a local currency in which the transaction was performed. The method further comprises periodically settling the accounts between the entities in each country using a central country bank account in each country, and periodically settling the accounts between each pair of central country bank accounts.

In some embodiments, periodically settling the accounts between the entities in each country comprises computing for each entity a net settlement amount that is the difference between the total of all amounts received into the stored value accounts by the entity during a period of time and the total of all redemptions from the stored value accounts performed within the entity during the period of time. For each entity having a positive net settlement amount, the net settlement amount is transferred from a bank account of the entity into the respective central country bank account. For each entity having a negative net settlement amount, the net settlement amount is transferred from the respective central country bank account into the entity bank account.

In some embodiments, settling the accounts between each pair of central country bank accounts comprises computing for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries. The cross-border net settlement amount is transferred from the central country bank account in the first country to the central country bank account in the second country.

In some embodiments, the method further comprises performing a currency conversion in conjunction with transferring each cross-border net settlement amount transferred between countries using different currencies.

In some embodiments, each redemption and reload transaction performed in one country on an account originated in a different country involves a paying entity and a receiving entity, the paying entity being obligated to transfer funds to the receiving entity as a result of the transaction, and the paying entity bears the risk of exchange rate fluctuations occurring between the time of a transaction and the time of cross-border account settlement.

In some embodiments, computation of the cross-border net settlement amount is performed based on amounts owed between entities at the time of each transaction in the currency of the entity to which finds are owed.

In some embodiments, each redemption and reload transaction performed in one country on an account originated in a different country involves a paying entity and a receiving entity, the paying entity being obligated to transfer funds to the receiving entity as a result of the transaction, and the receiving entity bears the risk of exchange rate fluctuations occurring between the time of a transaction and the time of cross-border account settlement.

In some embodiments, computation of the cross-border net settlement amount is performed based on amounts owed between entities at the time of each transaction in the currency of the entity owing funds.

In some embodiments, transferring the cross-border net settlement amount from the central country bank account in the first country to the central country bank account in the second country further comprises transferring the net settlement amount from the central country bank account in the first country to a first holding account provided in the first country by a settlement service provider, transferring the net settlement amount to a second holding account provided in the second country by the settlement service provider; and transferring the net settlement amount from the second holding account to the central country bank account in the second country.

In some embodiments, transferring the net settlement amount to the second holding account provided in the second country by the settlement service provider is accomplished through a global money movement service provider.

In some embodiments, the method further comprises transferring any small cross-border net settlement amounts using a first money transfer network, and transferring any large cross-border net settlement amounts using a second money transfer network different from the first.

In some embodiments, settling the accounts between each pair of central country bank accounts is performed daily, weekly, bi-weekly, semi-monthly, or monthly.

In some embodiments, the period between successive settlings of the accounts between the entities in each country is different than the period between successive settlings of the accounts between each pair of central country bank accounts.

In some embodiments, the frequency of settlements between one pair of central country bank accounts is different than the frequency of settlements between a different pair of central country bank accounts.

In some embodiments, at least one of the transactions is a reload transaction, and wherein during settling the accounts between each pair of central country bank accounts, the reload transaction is treated as an inverse redemption.

In another example embodiment, a system for settling accounts comprises a host computer system executing a program stored on a computer readable medium, and the host computer system is configured to receive transaction data resulting from a plurality of transactions performed at a plurality of merchants. The merchants are grouped into separate entities with separate accounting systems, and at least one entity operates in a different country than at least one other entity. The transactions relate to customer stored value accounts, and the plurality of transactions comprises any combination of origination transactions, redemption transactions, and reload transactions. The transaction data comprises for each redemption and reload transaction a transaction amount, a location in which the transaction occurred, a location in which the affected stored value account was originated, a base currency of the affected stored value account, and a local currency in which the transaction was performed. The host computer is further configured to periodically settle the accounts between the entities in each country using a central country bank account in each country, and periodically settle the accounts between each pair of central country bank accounts.

In some embodiments, the host computer system is further configured to, during periodically settling the accounts between the entities in each country, compute for each entity a net settlement amount that is the difference between the total of all amounts received into the stored value accounts by the entity during a period of time and the total of all redemptions from the stored value accounts performed within the entity during the period of time. For each entity having a positive net settlement amount, the system is configured to instruct that a transfer occur of the net settlement amount from a bank account of the entity into the respective central country bank account, and for each entity having a negative net settlement amount, the system is configured to instruct that a transfer occur of the net settlement amount from the respective central country bank account into the entity bank account.

In some embodiments, the host computer system is further configured to, during periodically settling the accounts between each pair of central country bank accounts, compute for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries. The system is also configured to instruct that a transfer occur of the cross-border net settlement amount from the central country bank account in the first country to the central country bank account in the second country.

In some embodiments, each redemption and reload transaction performed in one country on an account originated in a different country involves a paying entity and a receiving entity, the paying entity being obligated to transfer funds to the receiving entity as a result of the transaction, and the system is further configured to assign to the paying entity the risk of exchange rate fluctuations occurring between the time of a transaction and the time of cross-border account settlement.

In some embodiments, each redemption and reload transaction performed in one country on an account originated in a different country involves a paying entity and a receiving entity, the paying entity being obligated to transfer funds to the receiving entity as a result of the transaction, and the system is further configured to assign to the receiving entity the risk of exchange rate fluctuations occurring between the time of a transaction and the time of cross-border account settlement.

In some embodiments, the host computer system is further configured to, during instructing that a transfer occur of the cross-border net settlement amount from the central country bank account in the first country to the central country bank account in the second country, instruct that a transfer occur of the net settlement amount from the central country bank account in the first country to a first holding account provided in the first country by a settlement service provider, and to instruct that a transfer occur of the net settlement amount to a second holding account provided in the second country by the settlement service provider, and to instruct that a transfer occur of the net settlement amount from the second holding account to the central country bank account in the second country.

In some embodiments, the system is further configured to settle the accounts between each pair of central country bank accounts daily, weekly, bi-weekly, semi-monthly, or monthly.

In some embodiments, the system is further configured to settle the accounts between the entities in each country on a different periodic schedule from that of settling of the accounts between each pair of central country bank accounts.

In some embodiments, at least one of the transactions is a reload transaction, and the system is further configured to, during settling the accounts between each pair of central country bank accounts, treat the reload transaction as an inverse redemption.

In another embodiment, a method of settling financial accounts comprises receiving, at a host computer system, transaction data resulting from a plurality of transactions performed at a plurality of merchants. The merchants are grouped into separate entities with separate accounting systems, and at least one entity operates in a different country than at least one other entity. The transactions relate to customer stored value accounts, and the plurality of transactions comprises any combination of origination transactions, redemption transactions, and reload transactions. The transaction data comprises for each redemption and reload transaction a transaction amount, a location in which the transaction occurred, a location in which the affected stored value account was originated, a base currency of the affected stored value account, and a local currency in which the transaction was performed. At least two countries are grouped into a cooperative region and at least one entity operates in each of the two countries in the cooperative region. The method further comprises periodically settling the accounts between the entities in each country outside the cooperative region using a central country bank account in each of those countries, and periodically settling the accounts between the entities in the cooperative region using a central regional bank account, and periodically settling the accounts between each pair of central country bank accounts and between each central country bank account and the central regional bank account.

In some embodiments, periodically settling the accounts between the entities in each country outside the cooperative region comprises computing for each entity a net settlement amount that is the difference between the total of all amounts received into the stored value accounts by the entity during a period of time and the total of all redemptions from the stored value accounts performed within the entity during the period of time. For each entity having a positive net settlement amount, the net settlement amount is transferred from a bank account of the entity into the respective central country bank account and for each entity having a negative net settlement amount, the net settlement amount is transferred from the respective central country bank account into the entity bank account.

In some embodiments, periodically settling the accounts between the entities in the cooperative region comprises computing for each entity a net settlement amount that is the difference between the total of all amounts received into the stored value accounts by the entity during a period of time and the total of all redemptions from the stored value accounts performed within the entity during the period of time. For each entity having a positive net settlement amount, the net settlement amount is transferred from a bank account of the entity into the central regional bank account, and for each entity having a negative net settlement amount, the net settlement amount is transferred from the central regional bank account into the entity bank account.

In some embodiments, settling the accounts between each pair of central country bank accounts comprises computing for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries. The cross-border net settlement amount is transferred from the central country bank account in the first country to the central country bank account in the second country.

In some embodiments, settling the accounts between each central country bank account and the central regional bank comprises computing for each central country bank account and the central regional bank account a cross-border net settlement amount that is the difference between a) the net total value of redemption and reload transactions performed during a period of time in the country in which the central bank account resides and using accounts originated in the cooperative region and b) the net total value of redemption and reload transactions performed during the time period in the cooperative region using accounts originated in the country. The cross-border net settlement amount is transferred between the central country bank account and the central regional bank account.

In some embodiments, each redemption and reload transaction performed in a first country using a first currency on an account originated in a second country using a second currency involves a paying entity and a receiving entity, the paying entity being obligated to transfer finds to the receiving entity as a result of the transaction, and the paying entity bears the risk of exchange rate fluctuations occurring between the time of a transaction and the time of cross-border account settlement.

In some embodiments, each redemption and reload transaction performed in a first country using a first currency on an account originated in a second country using a second currency involves a paying entity and a receiving entity, the paying entity being obligated to transfer funds to the receiving entity as a result of the transaction, and the receiving entity bears the risk of exchange rate fluctuations occurring between the time of a transaction and the time of cross-border account settlement.

### BRIEF DESCRIPTION OF THE DRAWINGS

FIG. 1 illustrates a system and method of settling financial accounts, in accordance with an example embodiment of the invention.

FIG. 2 illustrates a cross-border transaction, in accordance with an example embodiment off the invention.

FIG. 3 illustrates a cross-border transaction, in accordance with another example embodiment off the invention.

FIG. 4 illustrates a system for settling accounts, in accordance with an example embodiment of the invention.

FIG. 5 lists example transactions for illustrating example embodiments of the invention.

FIG. 6 illustrates a system and method of settling financial accounts, in accordance with another example embodiment of the invention.

### DETAILED DESCRIPTION OF THE INVENTION

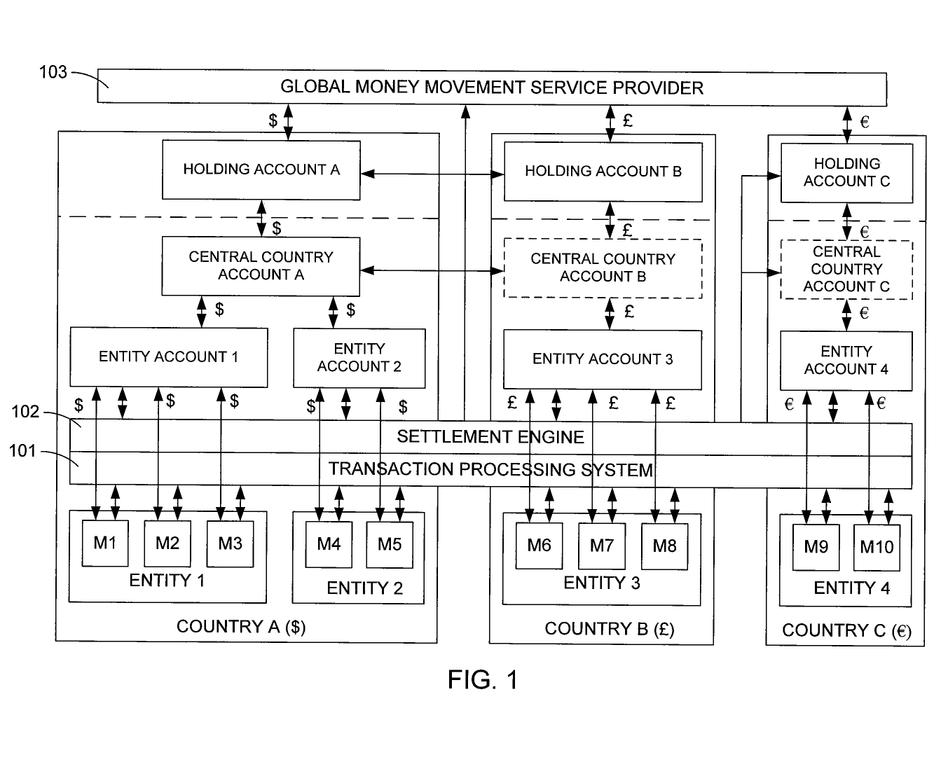

Embodiments of the invention provide systems and methods for settling stored value account transactions between merchants who used different currencies. FIG. 1 illustrates a system and method of settling financial accounts, in accordance with an example embodiment of the invention. A number of merchants M1 through M10 are grouped into entities 1 through 4. Each entity may be, for example a franchisee that operates one or more stores licensed or authorized by a franchisor. All of merchants M1 through M10 may appear to the general consumer to be part of a single large business, when in fact, individual merchants or groups of merchants may be independently operated, maintaining a consistent appearance under terms of a franchise agreement or other license. In FIG. 1, this arrangement is illustrated by the groupings of the merchants into entities, and the fact that each entity has its own entity account. For the purposes of this disclosure, a “group” may consist of a single merchant, or may comprise multiple merchants. (FIG. 1 is somewhat simplified in that it shows the accounts and relationships used for stored value card administration. Many other accounts and relationships may exist and be used for other purposes.) In FIG. 1, links that are marked with a currency symbol ($, £, [symbol] ) represent flows of money, while links without a currency symbol represent flows of information or instructions.

For stored value transactions occurring within a single country, administration and settlement may be handled in a manner similar to one of the methods described in pending U.S. patent application Ser. No. 10/356,207 of Baumgartner et al. titled “Financial settlement systems and methods” and filed on Jan. 30, 2003, the entire disclosure of which application is hereby incorporated by reference herein. For example, consider the simple case wherein a single stored value account is originated at merchant M1. Merchant M1 is part of entity 1, which is in country A, which uses U.S. dollars as currency. In the process of originating the account a consumer, who will be the account holder, gives merchant M1 an amount of money, for example $50. The origination transaction may be facilitated by transaction processing system 101, which may comprise a host computer system, communication links, and the like, and may receive information from point-of-sale devices, cash registers, and the like at the various merchants. Transaction processing system 101 may be, for example, the ValueLink system operated by First Data Corporation of Greenwood Village, Colo., USA. The $50 is deposited in entity account 1, and the consumer is given an account number or other account identifier associated with the account. Transaction processing system 101 records information about the origination transaction, including the transaction amount, the entity within which the activation occurred, the base currency of the account, and the account number. The base currency is the currency used by the entity where the account was originated. In this example, the base currency is U.S. dollars.

Periodically, an in-country settlement is performed, wherein excess stored value deposits are swept into central country account A, and redemptions are funded from central country account A. In this simple example, only one origination transaction has occurred, and during the in-country settlement, the $50 is transferred from entity account 1 to central country account A.

Now consider a second transaction, wherein the account holder redeems $25 of the value in the account at merchant M4. The account holder presents the account identifier, typically an account number stored on a card, at a point of sale for the purchase of goods or services from merchant M4. Transaction processing system 101 facilitates the transaction in the usual way. That is, transaction processing system reads the account number, verifies that sufficient funds remain in the account, approves the transaction, and deducts the redemption amount ($25) from the account. Transaction processing system 101 also provides information about the redemption transaction to settlement engine 102, including the transaction amount, the base currency of the account, the currency in which the redemption was performed (the same as the base currency in this example), the location in which the account was originated, and the location in which the redemption occurred. During the periodic in-country settlement, settlement engine instructs that $25 should be moved from central country account A to entity account 2. Entity 2 may recognize this $25 as revenue.

Within a country, a reload transaction is handled similarly to an origination transaction. Transaction processing system 101 reads the account number of the account to be reloaded and adds the reload amount to the account. The money received from the account holder is deposited in the entity account of the entity at which the reload occurred, and is then moved to the central country account during the in-country settlement process. Transaction processing system 101 also informs settlement engine 102 of the transaction and transmits the transaction information to settlement engine 102.

Of course in practice, many origination, reload, and redemption transactions may occur between in-country settlements. The transactions may occur in any combination. That is, all of the transactions occurring during a settlement period may be all of one type (origination, redemption, or reload), the transactions may all be of any two types (origination and redemption, or origination and reload, redemption and reload), or the transactions may comprise transaction of all three types (origination, redemption, and reload). Settlement engine 102 need not instruct that funds be transferred between accounts for every single transaction, but only need instruct that a net settlement amount be transferred. A net settlement amount is the difference between the total of all amounts received into stored value accounts by the entity during a period of time and the total of all redemptions from the stored value accounts performed within the entity during the period of time. For example if a stored value account is originated at merchant M2 in the amount of $100 and a redemption transaction in the amount of $25 is performed at merchant M3 (using the same or a different account), settlement engine 102 will recognize that the origination transaction alone would result in $100 being transferred from entity account 1 to central country account A, and the redemption transaction alone would result in $25 being transferred back from central country account A to entity account 1. In that case, settlement engine 102 will instruct that only a single net transaction be performed, transferring $75 from entity account 1 to central country account A. In this example, entity 1 had a positive net settlement amount, and the net settlement amount was transferred from the entity bank account into the central country bank account.

In another example, during a particular in-country settlement period, an entity may experience redemptions in a total amount greater that the total amount of reloads and originations experienced. For example, merchant M4 may redeem $100 of a particular account, and merchant M5 may experience a reload transaction of $30 for the same or a different account. If there are no other transactions within entity 2 during the settlement period, then entity 2 has a negative net settlement amount, in the amount of $70, and $70 will be transferred from the central country bank account into entity account 2.

Some enterprises are global in scope, and have franchised outlets on more than one country. In the example of FIG. 1, merchants M6 through M8 reside in country B which uses the British pound as its currency, and merchants M9 and M10 reside in country C which uses the euro as its currency. The franchiser may wish its outlets in each country to honor gift cards originated in all of the countries where franchisees operate. Fulfilling this desire is complicated by the need for currency conversion, by the complexity of global money movement, and by the fluctuation of monetary exchange rates. Systems and methods in accordance with embodiments of the invention enable use and settlement of stored value accounts between countries using different currencies.

In a simple example, consider a stored value account that has been originated and funded in US dollars within entity 2. After in-country settlement, the money provided by the consumer upon origination of the account resides in central country account A. The account holder may then travel to country B, and wish to redeem some of the stored value for a purchase made at merchant M7 in British pounds. Transaction processing system 101 may easily handle the actual purchase transaction in the usual way. For example, a point of sale device at merchant M7 may read the account number from a card presented by the account holder, perform a currency conversion, and verify that sufficient funds are in the account to make the proposed purpose. Assuming sufficient funds are present, transaction processing system 101 approves the transaction, and instructs that the purchase amount be deducted from the account. For example, the account holder may wish to buy a cup of coffee priced at £1.75, and the current exchange rate may be 2.00 US dollars per British pound. Transaction processing system recognizes that the base currency of the account is US dollars, converts the transaction amount of £1.75 into $3.50, verifies that the account contains at least $3.50, approves the transaction, and instructs that $3.50 be deducted from the account and moved into central country account A. In this scenario, entity 3 has suffered a detriment, as it was obligated to provide the coffee, but does not have ready access to the funds in the account used to pay for it. Also, central country account A has $3.50 for which no entity in country A was required to provide any goods or services.

In accordance with an example embodiment of the invention, accounts are periodically settled between each pair of central country bank accounts. In the simple example above, settling accounts between central country accounts A and B involves transferring money from central country account A to central country account B. The amount transferred is a cross-border net settlement amount, and is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries. In the example, this is the difference between a) £1.75 (the total value of redemptions performed in country B using accounts originated in country A) and b) zero (the total value of redemptions performed in country A using accounts originated in country B). Assuming that exchange rates have not fluctuated between the time that the redemption transaction took place and the cross-border settlement is performed, $3.50 is transferred from central country account A, converted to £1.75, and deposited into central country account B.

Settlement engine 102 calculates the cross-border net settlement amount based on the transaction information supplied to it by transaction processing system 101. For example, at the time of or after the redemption transaction at merchant M7, transaction processing system transmits transaction information to settlement engine 102. The transaction information includes the transaction amount (£1.75), a location in which the transaction occurred (country B, entity 4), a location in which the affected stored value account was originated (country A, entity 2), a base currency of the affected stored value account (US dollars), and a local currency in which the transaction was performed (British pounds). Given this information for each transaction, settlement engine 102 can calculate the cross-border net settlement amount to be transferred between each pair of central country accounts.

As with the in-country settlement, funds need not be transferred for every transaction—only net settlement amounts need be transferred. For the enterprise depicted in FIG. 1, up to three cross-border settlement transfers may be required for each cross-border settlement period—a transfer between central country accounts A and B, a transfer between central country accounts A and C, and a transfer between central country accounts B and C. The direction of transfer may differ between any two accounts from one settlement period to the next. That is, during one period, funds may be transferred from central country account B to central country account C, and during the next period funds may be transferred from central country account C to central country account B, depending on the relative value of redemptions and reloads performed in each country on accounts originated in the other country.

During cross-border settlement, a reload transaction is handled as an inverse redemption. For example, if the account holder of the account originated in country A in the above example is traveling in country B and wishes to add £20 to the balance of his or her stored value account, her or she can perform the reload transaction at any of merchants M6-M8. The account holder presents his or her card and the reload amount. Transaction processing system 101 reads the card and verifies the existence of the account and approves the transaction. The £20 is deposited in entity account 3, and swept into central country account B in the next in-country settlement. Transaction processing system 101 also informs settlement engine 102 of the transaction, providing the usual transaction information. During the next cross-border settlement, settlement engine 102 recognizes that central country account B is holding £20 that needs to be transferred to central country account A. This transaction is combined with all of the other redemptions and reloads occurring in country A or B on accounts originated in the other country, and the cross-border net settlement amount is adjusted by £20 or $40. That is, if the cross-border settlement results in a transfer of funds from central country account B to central account A, the amount deposited in central country account A is increased by $40 as a result of the reload performed in country B. If the cross-border settlement results in a transfer of funds from central country account A to central country account B, the transferred amount is reduced by £20 as a result of the reload (given that the current exchange rate is 2.00 dollars to the British pound).

During each cross-border settlement, the cross-border net settlement amounts are computed. For example the calculation may reveal that transfers listed below in Table 1 are needed:

TABLE 1

| | |
|---|---|
| Country A-B settlement | Transfer of £500 to country account B |
| Country B-C settlement | Transfer of £100 to country account B |
| Country A-C settlement | Transfer of $1200 to country account A |

Preferably, settlement engine 102 is operated by a settlement services provider, who may charge a fee for its service. Part of the service may be the maintenance of a holding account in each country, owned by the settlement services provider. The holding accounts facilitate the settlement process by simplifying arrangements with a global money movement service provider such as provider 103 shown in FIG. 1. Merely by way of example, global money movement services provider 103 may be the WorldLink service offered by Citigroup Global Transaction Services, or some other similar provider. The settlement services provider appears as a single customer to global money movement service provider 103, and establishment of the relationship is simplified as compared with establishing customer relationships between global money movement service provider 103 and each group of country entities. The efficiency is further improved if the settlement services provider provides settlement services for other enterprises similar to that shown in FIG. 1.

Once the transfer amounts such as those in Table 1 are known, the amounts are swept from the appropriate central country accounts and into the holding accounts, with appropriate currency conversions. Assuming the current exchange rates are 1£=$2.00, [symbol] =$1.5, and 1£= [symbol] 1.33, then $1000 is swept into holding account A (to fund the transfer of £500 to holding account B), [symbol] 133 is swept into holding account C (to fund the transfer of £100 to holding account B) and [symbol] 800 is swept into holding account C (to fund the transfer of $1200 to holding account A. Of course, the two transfers into holding account C may be combined into a single transfer of [symbol] 933.

Once the funds are available in the holding accounts, an instruction file is prepared and sent to global money movement service provider 103 for each transfer between country holding accounts. In this example, three instruction files are prepared, moving $1000 (£500) from holding account A to holding account B, [symbol] 133 (£100) from holding account C to holding account B, and $1200 ( [symbol] 800) from holding account C to holding account A). Global money movement service provider 103 may segregate the transfers in to large and small transfers, and use a different money transfer network for the large transfers than for the small transfers. The criteria for deciding which transfers are large and which are small will be specified by the respective money transfer networks.

Once the transfers between holding accounts are complete, the received finds are swept back into the central country accounts. In the above example, $1200 is moved from holding account A to central country account A, and £600 is moved from holding account B to central country account B. (No funds were received in this example into holding account C, so there is no transfer to central country account C for this particular settlement cycle.) In this example, the balance in each holding account is zero at the end of the settlement cycle, and the holding accounts exist only to facilitation transfers between the central country accounts.

Of course, the settlement services provider, global money movement services provider 103, or both may charge various fees for their services, which may be deducted from the transferred amounts. Any particular fee may be a flat per-transaction charge, may be a percentage of the transaction amount, or may be a combination of these, or may be computed in a different way. Fees have been neglected in the above simplified examples, but one of skill in the art will recognize what adjustments would be made to the transferred amounts, depending on the nature of the fees charged.

Both in-country settlement and cross-border settlement may occur periodically as desired by the enterprise. The periods between settlements need not be the same for in-country settlement and cross-border settlement. For example, in-country settlement may occur daily (or on some other cycle), while cross-border settlement may occur daily, weekly, bi-weekly, semi-monthly, monthly, or on some other cycle. Depending on the cycles chosen for in-country and cross-border settlements, there may be a delay of days or even weeks between a particular redemption or reload transaction and the cross-border settlement that settles that particular transaction. Exchange rates fluctuate constantly, and a significant change in a particular exchange rate may occur in the interim.

Preferably, all cross-border settlements are performed on the same settlement cycle, although this is not a requirement. That is, in the example of FIG. 1, cross-border settlements between countries A-B, B-C, and A-C are preferably performed at essentially the same time, and all of the holding accounts return to zero balances between cross-border settlements. In some other embodiments, the frequency of settlements between some pairs of countries could be different than the frequency of settlements between other pairs of countries. For example, settlement between countries A and B might be performed weekly, while settlement between countries A and C might be performed monthly. Many other scenarios are possible.

For example, in the above scenario, the account holder traveling in country B may buy a cup of coffee for £1.75. Transaction processing system 101 can make the currency conversion nearly instantaneously, and $3.50 may be deducted from the account holder's stored value account nearly immediately. 1mediately upon completion of the redemption transactions, entity 3 is owed £1.75 ($3.50) by central country account A for the transaction. However, the settlement during which entity 3 in country B gets reimbursed for the purchase using funds from central country account A may take place days or weeks later, after the exchange rate has changed.

For example, consider the case in which the exchange rate at the time of the redemption transaction was 1£=$2.00, while the exchange rate at the time of cross-border settlement is 1£=$2.10. The settlement process must decide how much must be transferred to settle this transaction. Central country account A could reimburse entity 3 the fall £1.75, which now requires a transfer of about $3.67 from central country account A. Or central country account A could be required to transfer only $3.50 (the cost at the time of the redemption), which results in entity 3 receiving only about £1.67. The assignment of risk of currency fluctuations is simply a business decision, and the risk may be assigned to either entity.

In one example embodiment, the computation of the cross-border net settlement amount is performed based on amounts owed between entities at the time of each transaction in the currency of the entity to whom funds are owed. Each cross-border net settlement amount transferred between countries using different currencies is computed so that each central country bank account receiving funds receives the cross-border net settlement amount in its local currency regardless of any exchange rate fluctuations occurring between the times of the transactions and the time of transferring the cross-border net settlement amount. In this arrangement, the paying country or entity takes the risk of currency fluctuations. Under this business rule in the example above, central country account A would be required to pay $3.67, so that entity 3 receives the full £1.75 that it normally would charge for the cup of coffee.

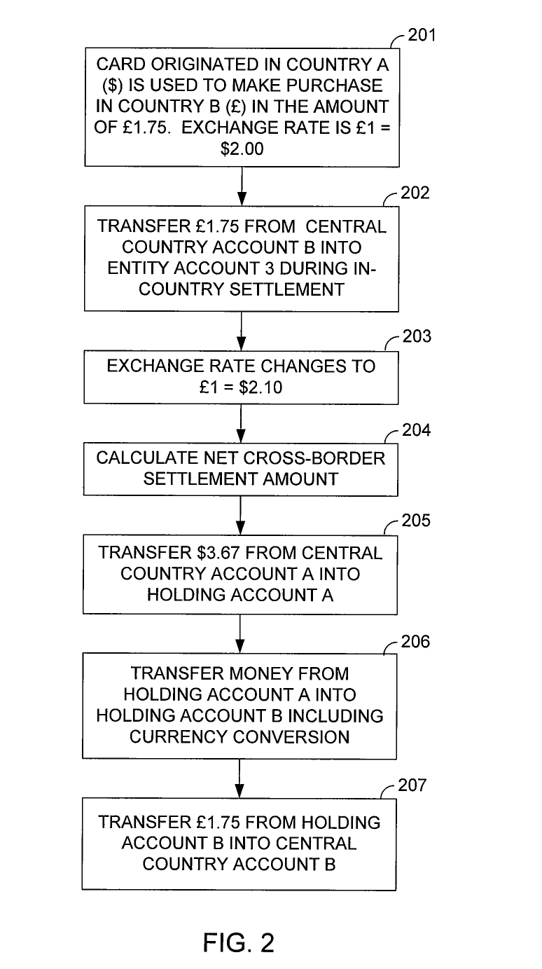

This example scenario is depicted in FIG. 2. In step 201, a gift card originated in country A in U.S. dollars is redeemed in country B to make a purchase in the amount £1.75. At the time of the redemption, the exchange rate is 1£=$2.00. In step 202, during the next in-country settlement, £1.75 is transferred from central country account B to entity account 3. In step 203, during the time between the transaction and cross-border settlement, the exchange rate changes so that 1£=$2.10. In step 204, the cross-border net settlement amount is calculated, resulting in a determination that $3.67 should be transferred from central country account A to central country account B in order to reimburse central country account B the full £1.75 at current exchange rates. In step 205, $3.67 is transferred from central country account A to holding account A. In step 206, the money is transferred cross-border from holding account A to holding account B, incurring a currency exchange in the process. This step may be facilitated by global money movement service provider 103. In step 207, £1.75 is transferred from holding account B to central country account B. Of course, this transfer may be aggregated with many other transfers settling many other transactions that occurred since the last cross-border settlement.

In another example embodiment, the computation of the cross-border net settlement amount is performed based on amounts owed between entities at the time of each transaction in the currency of the entity owing funds. Each cross-border net settlement amount transferred between countries using different currencies is computed so that each central country bank account sending funds sends the cross-border net settlement amount in its local currency regardless of any exchange rate fluctuations occurring between the times of the transactions and the time of transferring the cross-border net settlement amount. In this arrangement, the country or entity receiving payment takes the risk of currency fluctuations. Under this business rule in the example above, central country account A would be required to pay only $3.50 (the cost of the cup of coffee incurred at the time the coffee was bought), even though this means that entity 3 in country B receives only about £1.67.

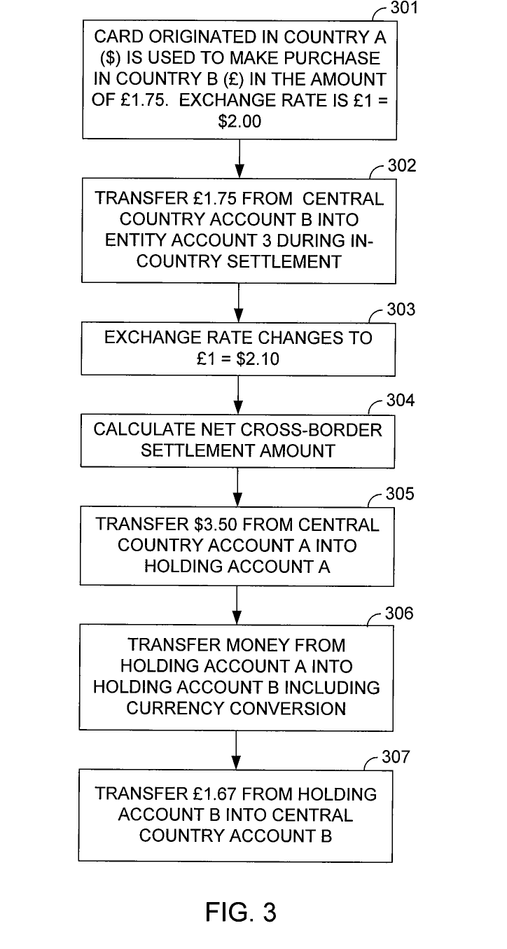

This example scenario is depicted in FIG. 3. In step 301, a gift card originated in country A in U.S. dollars is redeemed in country B to make a purchase in the amount £1.75. At the time of the redemption, the exchange rate is 1£=$2.00. In step 302, during the next in-country settlement, £1.75 is transferred from central country account B into entity account 3. In step 303, during the time between the transaction and cross-border settlement, the exchange rate changes so that 1£=$2.10. In step 304, the cross-border net settlement amount is calculated, resulting in a determination that $3.50 should be transferred from central country account A to central country account B, the amount of the purchase in U.S. dollars at the time of the redemption transaction. In step 305, $3.50 is transferred from central country account A to holding account A. In step 306, the money is transferred cross-border from holding account A to holding account B, incurring a currency exchange in the process. This step may be facilitated by global money movement service provider 103. In step 307, £1.67 is transferred from holding account B to central country account B. Of course, this transfer may be aggregated with many other transfers settling many other transactions that occurred since the last cross-border settlement.

The choice of which business rule to use is arbitrary. An enterprise may adopt the rule that the paying country or entity takes the risk of currency fluctuations, in order to encourage all franchisees or licensees to accept gift or other stored value cards. Under this rule, the entity providing goods or services is guaranteed to receive the full value of the goods or services, and does not risk receiving less if currency exchange rates move to the entity's detriment between the time of the redemption and the time of cross-border settlement. (Of course, the redeeming entity also loses the opportunity for a slight gain that might accrue if exchange rates move in a direction beneficial to it.)

Of course, many variations are possible within the scope of the appended claims. For example, an enterprise may operate in more or fewer countries than are represented in FIG. 1. Cross-border settlements may be made between dozens of countries. In another variation, when a country contains only one accounting entity, the entity account and the central country account (for example, entity account 3 and central country account B shown in FIG. 1) may be redundant, and only one or the other may be used. Central accounts B and C are depicted in FIG. 1 in dashed lines to indicate that they may be optional, and entity accounts 3 and 4 may serve their purpose.

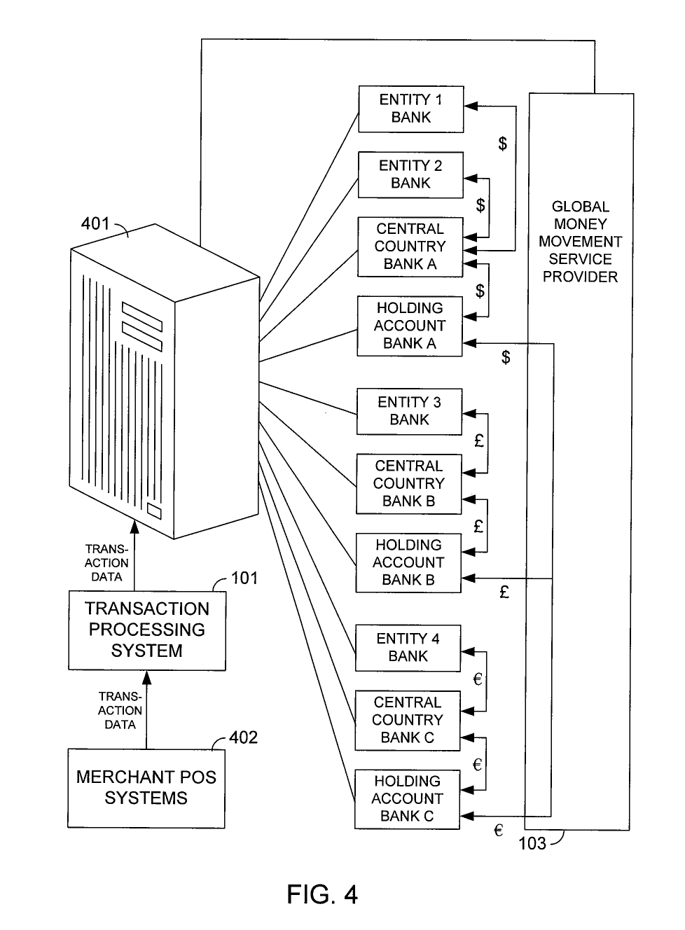

Settlement engine 102 may conveniently be implemented by a digital computer executing a program stored on a computer-readable medium. A settlement system in accordance with an example embodiment of the invention is shown in FIG. 4. Host computer system 401 implements the settlement calculations under control of a stored program. Host computer system 401 is represented in FIG. 4 as a single computer, but one of skill in the art will recognize that the system may comprise multiple computers in communication with each other, and that the multiple computers may be co-located or widely distributed. For example, in-country settlement may be performed in each country by a computer located in the respective country, while cross-border settlement may be conducted by a centralized system. Many arrangements are possible within the scope of the appended claims. Host computer system 401 may comprise a central processing unit, and various forms of volatile and non-volatile memory such as random access memory (RAM), read only memory (ROM), flash memory, cache memory, or other kinds of memory. Host computer system 401 may comprise one or more mass storage devices such as magnetic disks, optical disks, magneto-optical disks, tapes, or other kinds of mass storage. Host computer system 401 preferably comprises various kinds of input/output devices, especially network connections that enable it to send and receive data and messages to and from other computer systems. These communications may be sent over one or more private networks, public networks, or a combination of the two. Host computer system 401 may be connected to the Internet, and may utilize the Internet in its communications with other computer systems.

Host computer system 401 is in communication with the various banks at which accounts involved in the settlement process reside. For example, entity account 1 may reside at entity 1 bank, entity account 2 may reside at entity 2 bank, and so forth. Central country account A may reside at central country bank A, and similar terms are used for countries B and C. Holding accounts A, B, and C may be held at holding account banks A, B, and C respectively. Some of the various banks may also be in communication with each other, in order that funds may be transferred between them. In FIG. 4, links accompanied by a currency symbol ($, £, [symbol] ) represent monetary transfers, while other links represent flows of data or instructions, for example instructions to perform various money transfers. As is explained above, some accounts shown in FIG. 1 may be redundant and may be combined or eliminated, reducing the number of banks with which host computer system 401 may be in communication with. Or, a particular bank may hold more than one account shown in FIG. 1, further reducing the number of banks with which host computer system 401 must be in communication. For example, a single bank may hold entity account 1 and entity account 2.

Host computer system 401 is in communication with transaction processing system 101, and receives transaction data from transaction processing system 101. Transaction processing system 101 in turn receives transaction data from the various merchants, for example merchants M1-M10 shown in FIG. 1. At least some of the transaction data may be collected by point-of-sale devices 402 at the merchant locations.

Host computer system 401 is also in communication with global money movement service provider 103, so that host computer system 401 can instruct global money movement service provider to make the appropriate transfers between the various holding accounts.

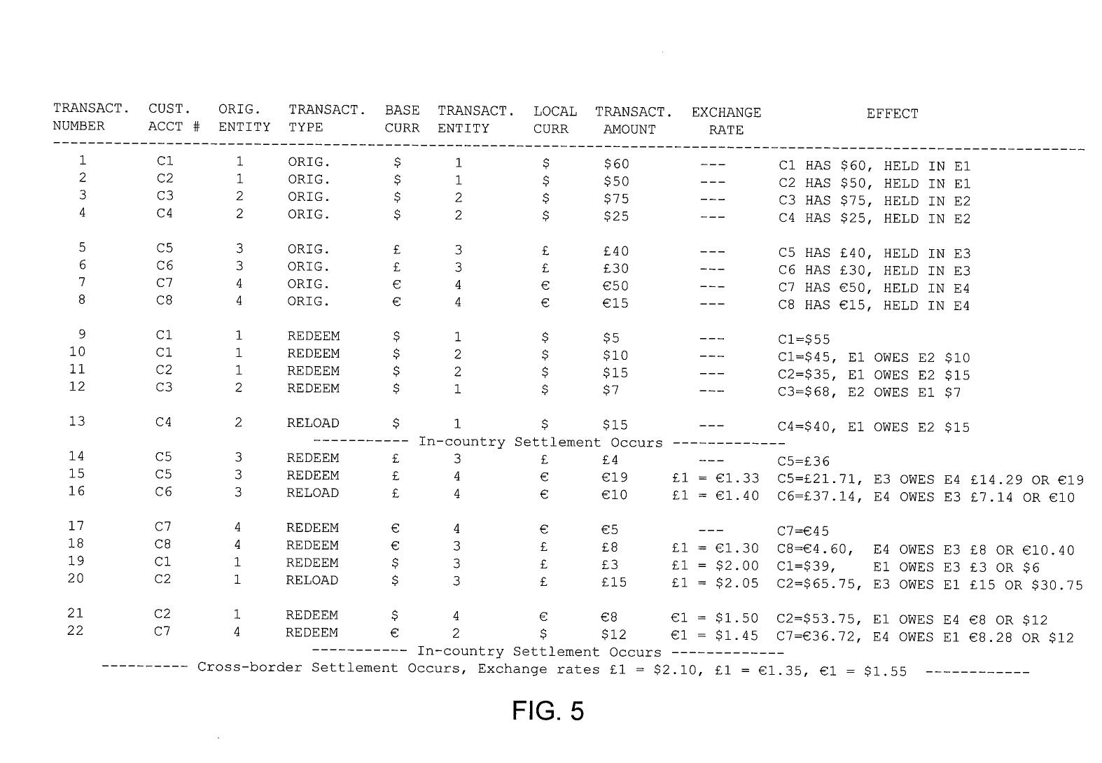

By way of further explanation, FIG. 5 lists several example transactions which may be made on customer accounts originated in the four entities illustrated in FIG. 1. In the first eight entries in the table, eight customer accounts C1-C8 are originated, two in each entity, and for varying amounts. The amounts deposited are held in the appropriate entity accounts. In FIG. 5, the entity account 1 is abbreviated E1, entity account 2 is abbreviated E2, and so forth. After the eight origination transactions, E1 holds $110, E2 holds $100, E3 holds £70 and E4 holds [symbol] 65.

The transactions in FIG. 5 are listed in chronological order, and the effects on the customer accounts are cumulative. For example, in transaction 9, customer account C1 is redeemed for $5, so the balance of account C1 drops from $60 to $55. In transaction 10, account C1 is redeemed for $10, and the balance of account C1 drops again, from $55 to $45. This reflects the fact that the transactions are handled nearly in real time, with the customer account balances being updated immediately after each transaction. Preferably, this is true for cross-border transactions as well. For example, in transaction 15, customer account C5, originated in entity 3 with a native currency of British pounds, is redeemed in entity 4 for a purchase costing [symbol] 19. Transaction processing system 101 recognizes that this is a cross-border transaction and that the currency conversion rate at the time of the transaction is £1= [symbol] 1.33. Customer account C5 is immediately debited by £14.29 (19/1.33).

Amounts that will be settled by settlement engine 102 are non-cumulative in FIG. 5, reflecting the fact that settlement is typically performed on a batch basis. For example, in transactions 10 and 11, customer accounts C1 and C2, both originated in entity 1, are redeemed in entity 2 for $10 and $15 respectively. Each of these transactions will eventually affect the next in-country settlement within country A. Both transactions will tend to increase the size of a net settlement amount transferred from central country account A to central country account B, or to decrease the size of a net settlement amount transferred from central country account B to central country account A. If in-country settlement were to be performed immediately after transaction 11, a net settlement amount of $25 ($10+$15) would be transferred from entity account 1 to central country account A, and a net settlement amount of $25 would also be transferred from central country account A to entity account 2.

In FIG. 5, and in-country settlement occurs after transaction 13. For each entity, a net settlement amount is computed as the difference between total receipts (from origination and reload transactions) and redemptions experienced in that entity since the previous in-country settlement. In the first 13 transactions of FIG. 5, each entity experienced the flows shown in Table 1 below.

TABLE 1
First in-country settlement

| | Total | Inflow | Total | Redemption | Net Settlement Amount |
|---|---|---|---|---|---|
| Entity | Inflows | Tranactions | Redempts | Transactions | and transfer |
| 1 | $125 | 1, 2, 13 | $12 | 9, 12 | $113 to central account A |
| 2 | $100 | 3, 4 | $25 | 10, 11 | $75 to central account A |
| 3 | £70 | 5, 6 | £0 | — | £70 to central account B |
| 4 | [symbol] 65 | 7, 8 | [symbol] 0 | — | [symbol] 65 to central account C |

Once the in-country settlement as occurred after transaction 13, the entities stand all square, each having been reimbursed for all redemptions and having swept any excess receipts to the appropriate central country account.

Another in-country settlement occurs after transaction 22. In this second batch of transactions, numbers 14-22, there are several cross-border transactions. The in-country settlements occur as shown in Table 2 below.

TABLE 2
Second in-country settlement

| | | | | | Net |
|---|---|---|---|---|---|
| | | | | | Settlement |
| | Total | Inflow | Total | Redemption | Amount |
| Entity | Inflows | Tranactions | Redempts | Transactions | and transfer |
| 1 | $0 | — | $0 | — | None |
| 2 | $0 | — | $12 | 22 | $12 to entity |
| | | | | | account A |
| 3 | £15 | 20 | £15 | 14, 18, 19 | None |
| 4 | [symbol] 10 | 16 | [symbol] 32 | 15, 17, 21 | [symbol] 22 to entity |
| | | | | | account C |

Once the second in-country settlement is completed, the entities once again stand all square. Each entity that had a net of inflow during the settlement period (none of the entities in this example) has moved its surplus to the appropriate central country account, and each entity that had more redemptions than originations and reloads (entities 2 and 4 in this example) has been reimbursed from its central country account. The flows in entity 3 exactly balanced, so no net settlement transfer was necessary.

Even though the entities are square, a particular central country account may have absorbed the cost of redemptions occurring in other countries on accounts originated in the particular country, or a particular central country account may hold funds from reloads that occurred in the particular country on accounts originated in other countries. The cross-border settlement adjusts the central country accounts to remedy these imbalances. In the example of FIG. 5, as many as three cross-border settlement transfers may be needed, one for each pair of central country accounts. It will be recognized that for other numbers of central country accounts, other numbers of transfers may be required. For example, if settlement engine 102 settles transactions between five countries, then as many as 10 transfers may be needed, as there are 10 possible combinations of two countries within a set of five countries. For 10 countries, as many as 45 transfers may be needed. Mathematically, the number of possible transfers is the combination of the number N of central country accounts taken two at a time, which can be expressed as

$$C ( N , 2 ) = \frac{N !}{2 ! ( N - 2 ) !} .$$

To perform the cross-border settlement on the transactions of FIG. 5, the transactions are sorted into three groups affecting the pairs of countries. The cross-border net settlement amounts are computed according to Table 3 below, for the case where the paying entity takes the risk of currency fluctuations. Note that exchange rates have fluctuated throughout the settlement period, and at the time of the cross-border settlement, are different than at any time during the period.

TABLE 3
Cross-border settlement, paying entity takes risk of
currency fluctuations.

| | | | | Net At | |
|---|---|---|---|---|---|
| | | Owing | Owing | Current | |
| | Transactions | First | Second | Exchange | Net Settlement Amount |
| Countries | Involved | Direction | Direction | Rate | and transfer |
| A and B | 19, 20 | £3 | $30.75 | $24.45 | $24.45 (£11.64) |
| | | | | £11.64 | transferred from central |
| | | | | | country account B to |
| | | | | | central country account A |
| A and C | 21, 22 | [symbol] 8 | $12 | $0.40 | [symbol] 0.25 ($0.40) |
| | | | | [symbol] 0.25 | transferred from central |
| | | | | | country account A to |
| | | | | | central country account C |
| B and C | 15, 16, 18 | [symbol] 19 | £15.14 | [symbol] 1.43 | £1.07 ( [symbol] 1.43) |
| | | | | £1.07 | transferred from central |
| | | | | | country account C to |
| | | | | | central country account B |

In the cross-border settlement between countries B and C, for example, there were three transactions that affected the settlement amount—transactions 15, 16, and 18. Transaction 15 was a redemption for a purchase in country C in the amount of [symbol] 9, using an account originated in country B in British pounds. For this transaction, entity 4 in country C has provided goods or services worth [symbol] 19, and is entitled to be reimbursed that amount, regardless of currency fluctuations occurring between the time of the transaction and the time of cross-border settlement (because in this example the paying entity takes the risk of currency fluctuations). Transaction 16 was a reload of an account originated in country B in British pounds, but the transaction was performed in country C, where the customer presented [symbol] 10. Customer account C6 was immediately credited £7.14 by transaction processing system 101, based on the exchange rate at the time of the transaction. At some time in the future, entity 3 will be obligated to provide goods or services worth £7.14, so entity 3 is entitled to that amount from entity 4. Finally, transaction 18 was a redemption for a purchase in country B in the amount of £8, using an account originated in country C in euros. Entity 3 in country B has provided goods or services worth £8, and is entitled to that amount from entity 4. So entity B owes entity C [symbol] 19, which is £14.07 at the current exchange rate of £1= [symbol] 1.35. Entity C owes entity B £15.14. The net of these is £1.07 owed from entity C to entity B, and this is the net cross-border settlement amount transferred as described above.

Of course, it is contemplated that the amounts involved in an actual system will be much larger than the amounts in this example, and will justify the costs or fees involved in the transfers. A settlement engine may record very small settlement amounts without instructing that funds be transferred, and roll the amounts into the next periodic settlement.

Table 4 below shows the cross-border settlement for the case where the receiving entity takes the risk of currency fluctuations.

TABLE 4
Cross-border settlement, receiving entity takes risk of
currency fluctuations.

| | | | | Net At | |
|---|---|---|---|---|---|
| | | Owing | Owing | Current | |
| | Transactions | First | Second | Exchange | Net Settlement Amount |
| Countries | Involved | Direction | Direction | Rate | and transfer |
| A and B | 19, 20 | $6 | £15 | £12.14 | £12.14 ($25.50) |
| | | | | $25.50 | transferred from central |
| | | | | | country account B to |
| | | | | | central country account A |
| A and C | 21, 22 | $12 | [symbol] 8.28 | $0.83 | $0.83 ( [symbol] 0.53) |
| | | | | [symbol] 0.53 | transferred from central |
| | | | | | country account A to |
| | | | | | central country account C |
| B and C | 15, 16, 18 | £14.29 | [symbol] 20.40 | [symbol] 1.11 | [symbol] 1.11 (£0.82) |
| | | | | £0.82 | transferred from central |
| | | | | | country account C to |
| | | | | | central country account B |

In the cross-border settlement between countries B and C, for example, there were three transactions that affected the settlement amount—transactions 15, 16, and 18. Transaction 15 was a redemption for a purchase in country C in the amount of [symbol] 19, using an account originated in country B in British pounds. For this transaction, entity 4 in country C has provided goods or services worth [symbol] 19. At the time of the transaction, customer account C5 was debited by £14.29, based on the exchange rate at the time of the transaction. Entity 3 should not be required to reimburse entity 4 more than this amount, regardless of currency fluctuations occurring between the time of the transaction and the time of cross-border settlement (because in this example the receiving entity takes the risk of currency fluctuations). Transaction 16 was a reload of an account originated in country B in British pounds, but the transaction was performed in country C, where the customer presented [symbol] 10. Customer account C6 was immediately credited £7.14 by transaction processing system 101, based on the exchange rate at the time of the transaction. Entity 4 should not be required to send more than it received, so entity 4 owes entity 3 [symbol] 10, regardless of fluctuations in exchange rates. Finally, transaction 18 was a redemption for a purchase in country B in the amount of £8, using an account originated in country C in euros. Entity 3 in country B has provided goods or services worth [symbol] 10.40 at the time of the transaction, and customer account C8 was debited by that amount. Entity 4 should not be required to send more than this during cross-border settlement. So entity B owes entity £14.29, which is [symbol] 19.29 at the current exchange rate of £1= [symbol] 1.35. Entity C owes entity B [symbol] 20.40. The net of these is [symbol] 1.11 owed from entity C to entity B, and this is the net cross-border settlement amount transferred as described above.

The choice of whether the paying or receiving entity takes the risk of currency fluctuations is a matter of business preference.

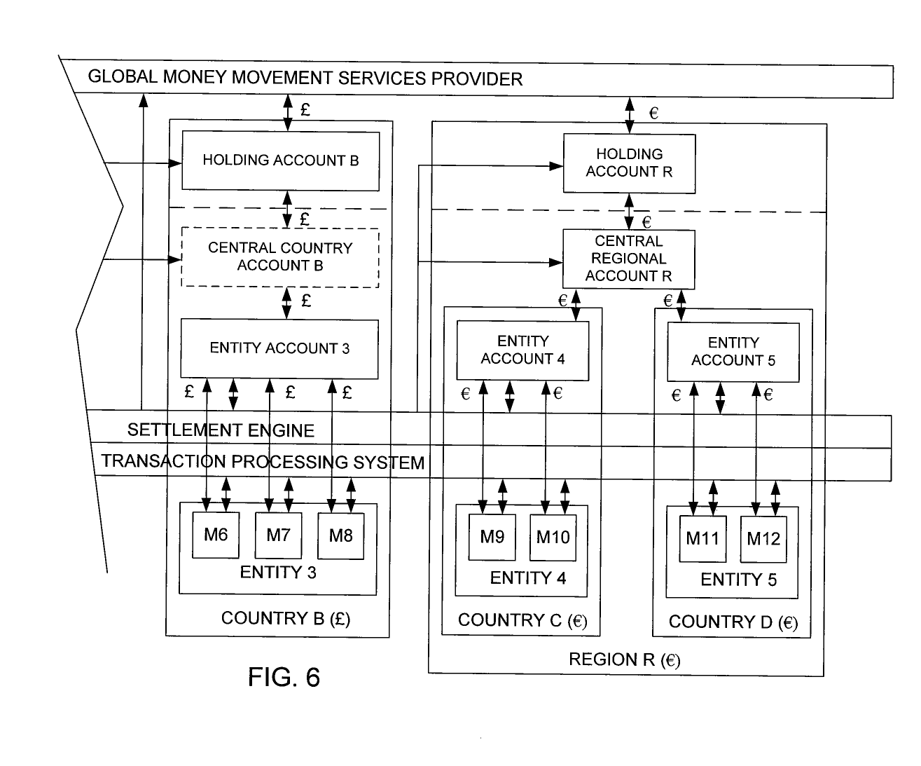

In an other example embodiment, a group of countries that use the same currency may be treated as a single country for settlement purposes. For example, residents of the Single Euro Payments Area (SEPA) may eventually be able to make euro-denominated transfers between accounts in different SEPA member countries without any additional complexity as compared with in-country transfers. In this scenario, some entities within SEPA may share a central regional account, and an in-region settlement may be performed rather than separate in-country settlements. The subsequent cross-border settlement then settles accounts between the central regional account and the various central country accounts of countries outside of the cooperative region. For the purposes of this disclosure, a cooperative region is a group of two or more countries that use the same currency and between which monetary transfers are uncomplicated by country borders. This arrangement is shown in FIG. 6.

In FIG. 6, merchants M11 and M12 have been added, residing on country D. (Country A has been sectioned off from the figure to allow room to show country D, but may still be present.) Merchants M11 and M12 are grouped into entity 5. Like country C, country D uses the euro as its currency, and both countries C and D reside in region R. Region R is served by a single regional euro-denominated account, central regional account R. Transfers can freely flow between entity accounts 4 and 5 and central regional account R.

The invention has now been described in detail for the purposes of clarity and understanding. However, those skilled in the art will appreciate that certain changes and modifications may be practiced within the scope of the appended claims.

What is claimed is:

1. A method of settling financial accounts, the method comprising:
receiving, at a host computer system, transaction data resulting from a plurality of transactions performed at a plurality of merchants, wherein the merchants are grouped into separate entities with separate accounting systems, wherein at least one entity operates in a different country than at least one other entity, wherein the transactions relate to customer stored value accounts, wherein the plurality of transactions comprises any combination of origination transactions, redemption transactions, and reload transactions, and wherein the transaction data comprises for each redemption and reload transaction a transaction amount, a location in which the transaction occurred, a location in which the affected stored value account was originated, a base currency of the affected stored value account, and a local currency in which the transaction was performed;
periodically settling the accounts between the entities in each country using a central country bank account in each country; and
periodically settling the accounts between each pair of central country bank accounts.

2. The method of claim 1, wherein periodically settling the accounts between the entities in each country comprises:
computing for each entity a net settlement amount that is the difference between the total of all amounts received into the stored value accounts by the entity during a period of time and the total of all redemptions from the stored value accounts performed within the entity during the period of time;
for each entity having a positive net settlement amount, transferring the net settlement amount from a bank account of the entity into the respective central country bank account; and
for each entity having a negative net settlement amount, transferring the net settlement amount from the respective central country bank account into the entity bank account.

3. The method of claim 1, wherein settling the accounts between each pair of central country bank accounts comprises:
computing for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries; and
transferring the cross-border net settlement amount from the central country bank account in the first country to the central country bank account in the second country.

4. The method of claim 3, further comprising performing a currency conversion in conjunction with transferring each cross-border net settlement amount transferred between countries using different currencies.

5. The method of claim 1, wherein each redemption and reload transaction performed in one country on an account originated in a different country involves a paying entity and a receiving entity, the paying entity being obligated to transfer funds to the receiving entity as a result of the transaction, and wherein the paying entity bears the risk of exchange rate fluctuations occurring between the time of a transaction and the time of cross-border account settlement.

6. The method of claim 5, wherein computation of the cross-border net settlement amount is performed based on amounts owed between entities at the time of each transaction in the currency of the entity to which funds are owed.

7. The method of claim 1, wherein each redemption and reload transaction performed in one country on an account originated in a different country involves a paying entity and a receiving entity, the paying entity being obligated to transfer funds to the receiving entity as a result of the transaction, and wherein the receiving entity bears the risk of exchange rate fluctuations occurring between the time of a transaction and the time of cross-border account settlement.

8. The method of claim 7, wherein computation of the cross-border net settlement amount is performed based on amounts owed between entities at the time of each transaction in the currency of the entity owing funds.

9. The method of claim 3, wherein transferring the cross-border net settlement amount from the central country bank account in the first country to the central country bank account in the second country further comprises:
transferring the net settlement amount from the central country bank account in the first country to a first holding account provided in the first country by a settlement service provider;
transferring the net settlement amount to a second holding account provided in the second country by the settlement service provider; and
transferring the net settlement amount from the second holding account to the central country bank account in the second country.

10. The method of claim 9, wherein transferring the net settlement amount to the second holding account provided in the second country by the settlement service provider is accomplished through a global money movement service provider.

11. The method of claim 3, further comprising transferring any small cross-border net settlement amounts using a first money transfer network, and transferring any large cross-border net settlement amounts using a second money transfer network different from the first.

12. The method of claim 1, wherein settling the accounts between each pair of central country bank accounts is performed daily, weekly, bi-weekly, semi-monthly, or monthly.

13. The method of claim 1, wherein the period between successive settlings of the accounts between the entities in each country is different than the period between successive settlings of the accounts between each pair of central country bank accounts.

14. The method of claim 1, wherein the frequency of settlements between one pair of central country bank accounts is different than the frequency of settlements between a different pair of central country bank accounts.

15. The method of claim 1, wherein at least one of the transactions is a reload transaction, and wherein during settling the accounts between each pair of central country bank accounts, the reload transaction is treated as an inverse redemption.

16. A system for settling accounts, the system comprising:
a host computer system executing a program stored on a computer readable medium, the host computer system configured to
receive transaction data resulting from a plurality of transactions performed at a plurality of merchants, wherein the merchants are grouped into separate entities with separate accounting systems, wherein at least one entity operates in a different country than at least one other entity, wherein the transactions relate to customer stored value accounts, wherein the plurality of transactions comprises any combination of origination transactions, redemption transactions, and reload transactions, and wherein the transaction data comprises for each redemption and reload transaction a transaction amount, a location in which the transaction occurred, a location in which the affected stored value account was originated, a base currency of the affected stored value account, and a local currency in which the transaction was performed;
periodically settle the accounts between the entities in each country using a central country bank account in each country; and
periodically settle the accounts between each pair of central country bank accounts.

17. The system of claim 16, wherein the host computer system is further configured to, during periodically settling the accounts between the entities in each country:
compute for each entity a net settlement amount that is the difference between the total of all amounts received into the stored value accounts by the entity during a period of time and the total of all redemptions from the stored value accounts performed within the entity during the period of time;
for each entity having a positive net settlement amount, instruct that a transfer occur of the net settlement amount from a bank account of the entity into the respective central country bank account; and
for each entity having a negative net settlement amount, instruct that a transfer occur of the net settlement amount from the respective central country bank account into the entity bank account.

18. The system of claim 16, wherein the host computer system is further configured to, during periodically settling the accounts between each pair of central country bank accounts:
compute for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries; and
instruct that a transfer occur of the cross-border net settlement amount from the central country bank account in the first country to the central country bank account in the second country.

19. The system of claim 18, wherein each redemption and reload transaction performed in one country on an account originated in a different country involves a paying entity and a receiving entity, the paying entity being obligated to transfer funds to the receiving entity as a result of the transaction, and wherein the system is further configured to assign to the paying entity the risk of exchange rate fluctuations occurring between the time of a transaction and the time of cross-border account settlement.

20. The system of claim 18, wherein each redemption and reload transaction performed in one country on an account originated in a different country involves a paying entity and a receiving entity, the paying entity being obligated to transfer funds to the receiving entity as a result of the transaction, and wherein the system is further configured to assign to the receiving entity the risk of exchange rate fluctuations occurring between the time of a transaction and the time of cross-border account settlement.

21. The system of claim 18, wherein the system is further configured to, during instructing that a transfer occur of the cross-border net settlement amount from the central country bank account in the first country to the central country bank account in the second country:
instruct that a transfer occur of the net settlement amount from the central country bank account in the first country to a first holding account provided in the first country by a settlement service provider;
instruct that a transfer occur of the net settlement amount to a second holding account provided in the second country by the settlement service provider; and
instruct that a transfer occur of the net settlement amount from the second holding account to the central country bank account in the second country.

22. The system of claim 16, wherein the host computer system is further configured to settle the accounts between each pair of central country bank accounts daily, weekly, bi-weekly, semi-monthly, or monthly.

23. The system of claim 16, wherein the host computer system is further configured to settle the accounts between the entities in each country on a different periodic schedule from that of settling of the accounts between each pair of central country bank accounts.

24. The system of claim 16, wherein at least one of the transactions is a reload transaction, and wherein the system is further configured to, during settling the accounts between each pair of central country bank accounts, treat the reload transaction as an inverse redemption.

25. A method of settling financial accounts, the method comprising:
receiving, at a host computer system, transaction data resulting from a plurality of transactions performed at a plurality of merchants, wherein the merchants are grouped into separate entities with separate accounting systems, wherein at least one entity operates in a different country than at least one other entity, wherein the transactions relate to customer stored value accounts, wherein the plurality of transactions comprises any combination of origination transactions, redemption transactions, and reload transactions, wherein the transaction data comprises for each redemption and reload transaction a transaction amount, a location in which the transaction occurred, a location in which the affected stored value account was originated, a base currency of the affected stored value account, and a local currency in which the transaction was performed, and wherein at least two countries are grouped into a cooperative region and at least one entity operates in each of the two countries in the cooperative region;
periodically settling the accounts between the entities in each country outside the cooperative region using a central country bank account in each of those countries;
periodically settling the accounts between the entities in the cooperative region using a central regional bank account; and
periodically settling the accounts between each pair of central country bank accounts and between each central country bank account and the central regional bank account.

26. The method of claim 25, wherein periodically settling the accounts between the entities in each country outside the cooperative region comprises:
computing for each entity a net settlement amount that is the difference between the total of all amounts received into the stored value accounts by the entity during a period of time and the total of all redemptions from the stored value accounts performed within the entity during the period of time;
for each entity having a positive net settlement amount, transferring the net settlement amount from a bank account of the entity into the respective central country bank account; and
for each entity having a negative net settlement amount, transferring the net settlement amount from the respective central country bank account into the entity bank account.

27. The method of claim 25, wherein periodically settling the accounts between the entities in the cooperative region comprises:
computing for each entity a net settlement amount that is the difference between the total of all amounts received into the stored value accounts by the entity during a period of time and the total of all redemptions from the stored value accounts performed within the entity during the period of time;
for each entity having a positive net settlement amount, transferring the net settlement amount from a bank account of the entity into the central regional bank account; and
for each entity having a negative net settlement amount, transferring the net settlement amount from the central regional bank account into the entity bank account.

28. The method of claim 25, wherein settling the accounts between each pair of central country bank accounts comprises:
computing for each pair of central country bank accounts a cross-border net settlement amount that is the difference between a) the net total value of redemption and reload transactions performed during a period of time in a first of the countries in which the central bank accounts reside and using accounts originated in the second of the countries and b) the net total value of redemption and reload transactions performed during the time period in the second of the countries and using accounts originated in the first of the countries; and
transferring the cross-border net settlement amount from the central country bank account in the first country to the central country bank account in the second country.

29. The method of claim 25, wherein settling the accounts between each central country bank account and the central regional bank comprises:
computing for each central country bank account and the central regional bank account a cross-border net settlement amount that is the difference between a) the net total value of redemption and reload transactions performed during a period of time in the country in which the central bank account resides and using accounts originated in the cooperative region and b) the net total value of redemption and reload transactions performed during the time period in the cooperative region using accounts originated in the country; and
transferring the cross-border net settlement amount between the central country bank account and the central regional bank account.

30. The method of claim 25, wherein each redemption and reload transaction performed in a first country using a first currency on an account originated in a second country using a second currency involves a paying entity and a receiving entity, the paying entity being obligated to transfer funds to the receiving entity as a result of the transaction, and wherein the paying entity bears the risk of exchange rate fluctuations occurring between the time of a transaction and the time of cross-border account settlement.

31. The method of claim 25, wherein each redemption and reload transaction performed in a first country using a first currency on an account originated in a second country using a second currency involves a paying entity and a receiving entity, the paying entity being obligated to transfer funds to the receiving entity as a result of the transaction, and wherein the receiving entity bears the risk of exchange rate fluctuations occurring between the time of a transaction and the time of cross-border account settlement.
